(19) United States
(12) Patent Application Publication
(10) Pub. No.: US 2018/0031863 A1
(43) Pub. Date: Feb. 1, 2018

(54) Toric Contact Lens Having A Ballast Mark Representing A Lens Identification Code

(71) Applicant: Novartis AG, Basel (CH)

(72) Inventor: Rene Ochrombel, Bergheim (DE)

(21) Appl. No.: 15/659,130

(22) Filed: Jul. 25, 2017

Related U.S. Application Data
(60) Provisional application No. 62/366,836, filed on Jul. 26, 2016.

(51) Int. Cl. G02C 7/04; B29D 11/00; G02C 7/02

(52) U.S. Cl. CPC G02C 7/04; G02C 7/021; B29D 11/00923; B29D 11/00057

(57) ABSTRACT

A toric contact lens (1) having a front surface and a rear surface, one of said front and rear surfaces includes a toric optical zone and a lens edge surrounding the contact lens (1). The contact lens further has a ballast axis (3) and includes at least one ballast mark (41, 42, 43) identifying the position of the ballast axis (3). Each ballast mark (41, 42, 43) includes a one-dimensional dot pattern (5) having a lens identification code and being arranged to extend radially towards the lens edge at an angular position relative to the position of the ballast axis (3). The angular position of the one-dimensional dot pattern identifies the position of the ballast axis.

This application claims the benefit under 35 U.S.C. §119 (e) of U.S. provisional application Ser. No. 62/366,836 filed on Jul. 26, 2016, incorporated herein by reference in its entirety.

### FIELD

The invention relates to toric contact lenses comprising a ballast mark representing a lens identification code, and further relates to a method of manufacturing a toric contact lens comprising such ballast mark in an automated production line. In particular, the toric contact lenses are hard or soft contact lenses.

### BACKGROUND

In mass production of soft contact lenses, specifically soft contact lenses which are worn only once and which are disposed of after use, a large number of soft contact lenses must be manufactured in a relatively short period of time. This may be performed with the aid of reusable molds comprising male and female mold halves in a closed-loop production process. Typically, a lens forming material is introduced into one of the male and female mold halves, the mold halve are then assembled to form the mold, and the lens forming material between the molding surfaces of the male and female mold halves is then polymerized and/or cross-linked, to form the lens. After demolding of the lens, the reusable molds are cleaned and dried and are then reused for production of the next lens. Suitable lens forming materials include, but are not limited to, polymers and prepolymers based on polyvinyl alcohols (PVA) or silicone hydrogels (SiHy).

In order to meet the needs of the user, large numbers of contact lenses having different lens parameters must be produced, in particular as regards contact lenses for single use only. Such lens parameters include, but are not limited to, refractive power, base curve radius, axes of toric lenses, etc. Thus, in order to be able to carry out all incoming orders within a short time large numbers of different types of contact lenses must be produced and held on stock, the different types of contact lenses being distinct from each other in at least one lens parameter.

In the closed-loop production process, a certain number of contact lenses which may or may not be of different types are produced in one run through the loop, that is to say until the male and female mold halves are re-used again in a further run through the loop. Accordingly, a corresponding number of pairs of male and female mold halves are used in the production line. Each such pair of male and female mold halves used in the production line is called a “lot”, so that the number of lots corresponds to the number of pairs of male and female mold halves actually used in the production line. All contact lenses produced in the various loops of the production process with the same pair of male and female molds halves belong to the same lot.

For each contact lens produced, a clear allocation of the contact lens produced to the respective lot is vital for various reasons, and also a mix-up of lots must be avoided. By way of example, in case a problem is reported by a customer with respect to a particular contact lens (a contact lens having a particular set of lens parameters) it is helpful if the corresponding lot can be identified (that pair of male and female mold halves which has been used for the production of the particular contact lens that has caused the problem). Thus, it is vital that each contact lens can be clearly allocated to the respective lot and also to avoid lot mix-up. In case each contact lens can be allocated to the respective lot, it is possible to check whether the mold halves that have been used for production of the particular contact lens that has caused the problem are in optimum condition. This is even more important in case a problem reoccurs within the same lot.

Additionally, for toric contact lenses, it is known to mark the ballast axis. Such lenses are useful for measuring the rotational position of the lens on the eye, i.e., a practitioner or the patient can evaluate the lens rotation when placed on the eye, and use the markings to measure any deviation of the lens from its intended rotational position, and to evaluate whether rotation of the toric lens on the eye is effectively inhibited as intended.

### SUMMARY

The present invention suggests a method and a device as it is specified by the features of the independent claim. Advantageous aspects of the device according to the invention are the subject matter of the dependent claims.

Throughout the entire specification, whenever the term “mold” or “lens mold” is used this term is to be understood to also denote only a part of an entire lens mold such as, for example, a mold half. Also, as used in the specification including the appended claims, the singular forms “a”, “an”, and “the” include the plural, unless the context explicitly dictates otherwise. When using the term “about” with reference to a particular numerical value or a range of values, this is to be understood in the sense that the particular numerical value referred to in connection with the “about” is included and explicitly disclosed, unless the context clearly dictates otherwise. For example, if a range of “about” numerical value a to “about” numerical value b is disclosed, this is to be understood to include and explicitly disclose a range of numerical value a to numerical value b. Also, whenever features are combined with the term “or”, the term “or” is to be understood to also include “and” unless it is evident from the specification that the term “or” must be understood as being exclusive.

The present invention suggests a toric contact lens having a front surface and a rear surface. One of said front and rear surfaces include a toric optical zone and a lens edge surrounding said contact lens. Said contact lens further has a ballast axis and comprises at least one ballast mark identifying the position of the ballast axis. Each ballast mark comprises a one-dimensional dot pattern comprising a lens identification code and being arranged to extend radially towards the lens edge at an angular position relative to the position of the ballast axis. The angular position of the one-dimensional dot pattern identifies the position of the ballast axis.

In a further aspect of the toric contact lens according to the present invention the one-dimensional dot pattern represents a binary code including the lens identification code.

According to a further aspect of the toric contact lens according to the invention, each of the front and rear surfaces comprise a central optical zone which is surrounded by a peripheral zone, and wherein the one-dimensional dot pattern is arranged in the peripheral zone of the contact lens.

According to a still further aspect of the toric contact lens according to the invention, the at least one ballast mark is arranged on the front surface of the contact lens.

Still in accordance with another aspect of the toric contact lens according to the invention, the contact lens includes two ballast marks, the two ballast marks being symmetrically arranged at angular positions relative to the ballast axis.

In accordance with a further aspect of the toric contact lens according to the invention, when the contact lens includes two ballast marks symmetrically arranged at angular positions relative to the ballast axis, the two ballast marks are arranged on an axis running perpendicular to the ballast axis through a center of the contact lens, and the two ballast marks are arranged at diametrical opposite locations on the peripheral portion of the contact lens.

According to a further aspect of the toric contact lens according to the invention, the contact lens includes a vertical ballast mark, formed by a one-dimensional dot pattern representing a lens identification code, coinciding with the ballast axis.

According to an additional aspect of the toric contact lens according to the invention, the contact lens includes a single ballast mark only which is arranged to coincide with the ballast axis.

Another aspect of the invention relates to a method of manufacturing of toric contact lenses, the method comprising the steps of:
providing a mold for the manufacture of toric contact lenses having a ballast axis and a lens edge surrounding said contact lens,
introducing a lens forming material into the mold,
transporting the mold through a plurality of manufacturing stations sequentially arranged along the production line to manufacture said contact lenses from the lens forming material, and
applying at least one ballast mark to each of said toric contact lenses,

wherein the step of applying at least one ballast mark to each of said contact lens comprises applying at least one ballast mark comprising a one-dimensional dot pattern including a lens identification code at an angular position relative to the ballast axis in a manner such that the at least one ballast mark extends radially towards the lens edge of the respective contact lens, the angular position of the one-dimensional dot pattern being arranged to identify the position of the ballast axis.

According to a further aspect of the method according to the invention, the one-dimensional dot pattern represents a binary code including the lens identification code.

In yet some further embodiments of the method according to the present invention, the step of applying the one-dimensional dot pattern to each of said toric contact lens comprises
applying the one-dimensional dot pattern to a peripheral zone of a molding surface, of the respective mold, and
transferring the one-dimensional dot pattern from the peripheral zone of the respective molding surface of the mold to the peripheral zone of the respective contact lens.

Yet in accordance with another aspect of the method according to the invention, the one-dimensional dot pattern is applied to the molding surface of the mold using an ink-jet printer.

According to a further aspect of the method according to the invention, the one-dimensional dot pattern is applied to the molding surface of the mold using a valve jet printer.

Several methods are known in the art for maintaining the intended orientation on the wearer's eye. The front and rear surfaces of the toric contact lens may be, for example, shaped to form a ballast oriented about the ballast axis. Alternatively, a slab-off may be used for maintaining the intended orientation of the contact lens on the wearer's eye. In this case, the contact lens may not have a ballast for maintaining the lens in the correct orientation.

Independently from the method applied for maintaining the intended orientation of the contact lens on the wearer's eye, the toric contact lens has a ballast axis which corresponds to an intended vertical axis having a top intended to be located at the top of the wearer's eye and bottom intended to be located at the bottom of the wearer's eye. This convention therefore also applies to lenses not having a ballast and using another method such as a slab-off for maintaining the orientation on the wearer's eye. The ballast axis may therefore be identical to the toric axis of the contact lens.

The use of a combination of an identification code for the lot number and other lens parameters as one-dimensional dot pattern forming the ballast mark for the ballast axis reduces the number of marks on the toric contact lens which in sum could lead to a contact lens which is uncomfortable to wear by the patient. Additionally, this combination simplifies the manufacturing of such toric contact lens, as the application of the one-dimensional dot pattern may be done using very simple, yet very efficient techniques. With the aid of the one-dimensional dot pattern used for identifying the ballast axis, the practitioner can estimate the amount of rotation of the toric contact lens from the intended vertical axis on the wearer's eye.

The one-dimensional dot pattern is a line dot pattern; the dots are arranged on a straight line.

The lens identification code can be easily read using suitable existing devices. For example, conventional dot-code readers can be used which can be equipped with software allowing for reading of the lens identification number with the aid of which additional information on the lens can be retrieved from a database via Internet. Alternatively, it is conceivable to provide a software that can be downloaded by a user to his/her smart-phone so that the camera of the smart-phone can then read the lens identification number with the aid of which additional information on the lens can be retrieved via Internet from a database.

The use of a binary code including the lens identification code has the advantage of being simple and invariant relatively to symmetry operations by inversion, by rotation or by reflection when read-out.

Depending on the number of binary dots, the binary code represented by the one-dimensional dot pattern allows to identify a wide range of lens information of each individual lens. The information contained in the binary code allows for allocation of each individual lens to its lot. Additional information may however be included in the binary code. By way of example, the binary code may include information concerning the lens manufacturer (so that the lens identification code can be used as a security feature), the location where the lens has been manufactured, information on the lens parameters, production year, etc.

Arranging the one-dimensional dot pattern in the peripheral zone reduces the visibility of the ballast mark for the wearer's comfort. The space needed for applying such one-dimensional dot pattern is very small so that it can be easily arranged in the peripheral portion of a toric contact lens such as a soft contact lens.

A contact lens including two ballast marks being symmetrically arranged at angular positions relative to the ballast axis, allows for an easy and rapid evaluation of the position of the toric lens by the practitioner on the wearer's eye by allowing simple evaluation of the position of the ballast axis situated in the center of the symmetrically positioned on both sides of the ballast axis.

A contact lens including two ballast marks symmetrically arranged at angular positions relative to the ballast axis, the two ballast marks are arranged on an axis running perpendicular to the ballast axis through a center of the contact lens, allows for a simplified evaluation of the position of the toric lens by the practitioner on the wearer's eye by estimating the deviation of the two one-dimensional dot patterns from a horizontal line on the wearer's eye. Additionally, this embodiment makes the manufacture of the contact lens very easy as the application of the one-dimensional dot pattern may be done while the contact lens or the contact lens mold is linearly transported at the vicinity of the device applying the done-dimensional dot pattern without having to rotate the contact lens or the lens mold.

A contact lens including a vertical ballast mark, which is arranged to coincide with the ballast axis is particularly advantageous in case the toric contact lens is non-symmetric and cannot be rotated by 180° (upside-down) on the patient's eye. A single vertical mark may be arranged in the upper half or in the lower half of the contact lens and will indicate to the practitioner or to the patient, in which rotational position the lens has to be placed onto the eye. The practitioner or patient will be instructed whether the mark has to be in the upper or in the lower part of the eye for proper position and will have a simplified indication as to the position of the lens on the wearer's eye.

A contact lens comprising a combination of a ballast mark coinciding with the ballast axis and two ballast marks symmetrically arranged relative to the ballast axis which particularly may be perpendicular to the ballast axis at diametrical opposite points of the peripheral portion of the contact lens has the additional advantage of offering simple and accurate evaluation of a rotational deviation of the position of the contact lens on the wearer's eye for the practitioner as well as an indication of the overall rotation of the contact lens (upside-down) for the practitioner or the patient.

The advantages of the method according to the invention are already mentioned above in connection with the toric contact lens according to the invention. Additionally, the method according to the present invention allows for a very simple set-up in a production line and implementation in an existing production line.

The dot pattern may be an ink dot pattern, which is a practical embodiment of the one-dimensional dot pattern, which can be easily applied to the peripheral zone of the molding surface of the mold using commercially available devices. Alternatively, a wax, particularly a paraffin may be applied to the molding surface. Wax has the advantage of being easily washed of the molding surface in the subsequent washing step, and from the contact lens, in which the dot pattern has been integrated when the lens was formed, during the subsequent treatment steps.

The valve-jet printer, in particular a piezo-driven dispenser head, is a very cost efficient marking tool which is very fast and accurate in dispensing droplets and very well adapted for applying a one-dimensional dot pattern according to the invention. The piezo-driven dispenser head is based on piezo-driven inkjet printing technology and allows for applying very fast and accurately droplets onto the lens mold. Such valve-jet printer additionally highly reduces the cleaning efforts and thereby simplifying the process and decreasing the risk of failure during manufacturing of the contact lenses.

The afore-mentioned embodiments are practical embodiments of transferring the lens identification code from the mold (or from a mold half, respectively) to the toric contact lens as the lens is formed during lens manufacture.

Further embodiments and advantages become apparent from the following description of detailed embodiments of the toric contact lens according to the invention with the aid of the drawings.

It is to be noted, that every individual feature described herein as well as all combination of two or more of such features are possible as long as such features are not mutually exclusive or are otherwise technically incompatible.

### BRIEF DESCRIPTION OF THE DRAWINGS

FIG. 1 shows an embodiment of a toric contact lens according to the invention comprising ballast and a ballast marl representing simultaneously representing a lens identification code in the form of a one-dimensional dot pattern.

FIG. 2 shows a second embodiment of a toric contact lens according to the invention.

FIG. 3 shows a third embodiment of a toric contact lens according to the invention.

FIG. 4 is an enlarged view of on example of a one-dimensional dot pattern of the lens shown in FIG. 1, 2 or 3.

FIG. 5a is a schematic view of one embodiment of the method of applying a one-dimensional dot pattern to a mold according to the invention.

FIG. 5b is a schematic view of the mold according to FIG. 5a after applying a one-dimensional dot pattern.

FIG. 6 is a block diagram of a closed cycle production line for the manufacture of contact lenses.

### DETAILED DESCRIPTION OF EMBODIMENTS

The following description of an exemplary embodiment of the invention is for illustrative purposes only and is not intended to limit of the scope of the invention.

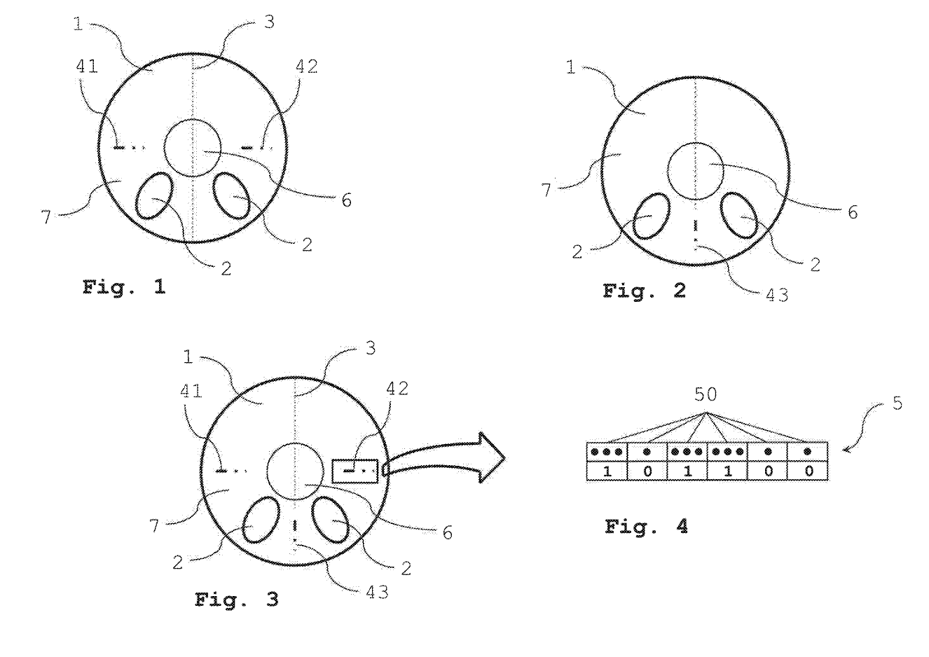

FIGS. 1, 2 and 3 show a toric contact lens, for example a soft contact lens in accordance with the invention. The contact lens 1 is shown in a view at its front surface. In a peripheral zone 7 of the front surface surrounding a central optical zone 6 of the front surface of the contact lens 1 there is arranged at least one ballast mark 41, 42, 43 formed by a one-dimensional dot pattern 5 representing a lens identification code corresponding to the lens. This one-dimensional dot pattern 5 represents a binary code as can be seen from FIG. 4, that is to say a code in which the single dot elements of the one-dimensional dot pattern are of two different types, thereby forming binary elements. For example, one type of dot elements may represent the value “0” while the other type of dot elements may represent the value “1”. By having the one-dimensional binary dot pattern 5 arranged in the peripheral zone 7 of the contact lens 1, the one-dimensional binary dot pattern 5 does not affect vision correction which is provided by the central optical zone 6 of the contact lens 1.

FIG. 1 depicts a particular embodiment of the toric contact lens according to the invention. The lens shown in FIG. 1 has two symmetric ballast marks 41, 42 each formed by a one-dimensional dot pattern arranged symmetrically about the ballast axis 3. In this specific embodiment, the symmetric ballast marks 41, 42 formed by the one-dimensional binary dot pattern 5 are arranged on an axis perpendicular to the ballast axis 3 at diametrical opposite points of the peripheral portion of the contact lens 1. When worn by the patient, these one-dimensional dot patterns 5 form lines which shall coincide with an imaginary horizontal line on the wearer's eye and determine the intended rotational position of the toric contact lens on the eye of the patient indicating the practitioner the rotation of the toric lens on the wearer's eye.

In FIG. 2, a further embodiment is shown in which only one vertical ballast mark 43 formed by a one-dimensional binary dot pattern 5 is arranged on the contact lens 1. The ballast mark 43 formed by the one-dimensional binary dot pattern coincides with the ballast axis 3 and shall therefore be oriented on a vertical line when placed on the wearer's eye. Similarly to the symmetric ballast marks 41, 42 symmetrically arranged on both sides of the ballast axis 3 in FIG. 1, the vertical ballast mark 43 coinciding with the ballast axis 3 will coincide with an imaginary vertical line on the wearer's eye and determine the intended rotational position of the toric contact lens on the eye of the patient.

FIG. 3 shows an additional embodiment according to the present invention. The toric contact lens 1 has three ballast marks 41, 42 and 43, each being formed by a one-dimensional binary dot pattern located in the peripheral zone 7 of the contact lens 1. A first vertical ballast mark 43 is located on the ballast axis 3. Second and third symmetric ballast marks 41 and 42 are located on either side of first vertical ballast mark 43 such that their extensions would pass through geometrical center of corneal section forming two 90° angles.

FIG. 4 shows in an enlarged view an embodiment of the one-dimensional binary dot pattern 5 representing the lens identification code of the corresponding toric contact lens and forming the ballast mark 41, 42, 43. The dots of the dot pattern 5 are arranged on a straight line and hence form a one-dimensional pattern. In the embodiment shown, a one-dimensional binary dot pattern comprising 6 binary elements forming the code is represented. This combination allows for an encoding having 64 different possibilities for the lens identification code.

It is to be noted, that the one-dimensional binary dot pattern 5 generally can have an arbitrary number of binary elements. In particular, the size of the one-dimensional binary dot pattern 5 remains small enough to fit into the peripheral zone 7 of the contact lens 1 so that it does not interfere with the central optical zone 6 of the contact lens 1. The methods for manufacturing such lenses allow a high number of binary elements to be integrated into the peripheral zone 7, such that information may easily be incorporated into the front or rear surface of the toric contact lens.

The contact lens 1 according to the invention has an imaginary vertical axis coinciding with the ballast axis 3. This imaginary vertical line or ballast axis has a top which is intended to be located at the top of the wearer's eye and a bottom intended to be located at the bottom of the wearer's eye and will coincide with a true vertical in the wearer's eye. The contact lens 1 according to the embodiments shown in the figures has ballast elements 2 to maintain the lens at its intended orientation, i.e. with the top of axis at the top of the eye and the bottom of axis at the bottom of the eye. Other techniques for maintaining the toric contact lens in the intended rotational position, such as slab-off, may be used.

In order to measure the rotational position of lens 1 when it is on the eye of the intended wearer, the practitioner locates the ballast mark 41, 42, 43 formed by the one-dimensional binary dot pattern 5. The rotational position of the lens is the angle formed between the ballast axis 3 identified by the ballast marks 4 and the true (imaginary) horizontal or vertical axis of the wearer's eye, not shown. Accordingly, when the practitioner measures rotation using the lens of FIG. 1, 2 or 3 he actually measures the angle formed by the ballast mark 41, 42, 43 and the true horizontal or true vertical.

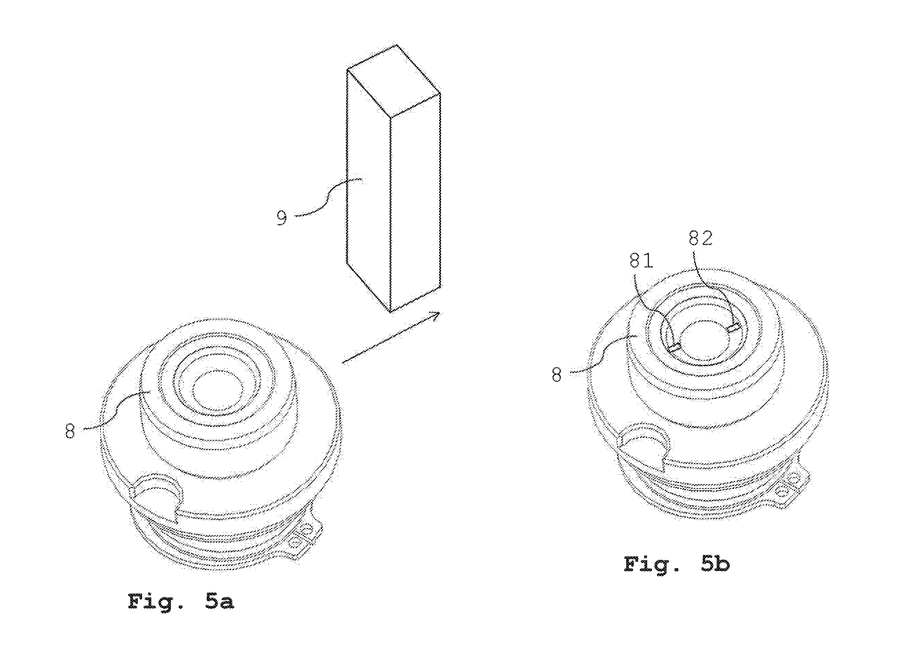

One embodiment for applying such one-dimensional dot pattern onto the molding surface of a mold 8 is the use of valve-jet printer such as the commercially available Microdrop Dispenser Heads® as shown in FIG. 5a, the printer head 9 of which is represented. These dispensers are based on piezo-driven inkjet printing technology. The integrated piezo actuator induces a shock-wave into the fluid contained in the head, which causes a droplet to be emitted from the nozzle. An ink-jet printer head may alternatively be used. As the mold 8 is transported (using a suitable transportation device, not shown) along a linear transport path (indicated by the arrow shown in FIG. 5a) the mold 8 is exposed to the valve-jet printer head 9. During the transportation of the mold, the one-dimensional dot pattern is applied to the peripheral zone of a molding surface of the respective mold 8 by the valve-jet printer head 9. FIG. 5b shows the mold according to FIG. 5a after applying two one-dimensional dot patterns 81 and 82 onto the molding surface of the mold 8.

As has been discussed in detail above, the one-dimensional dot pattern 5 represents a binary code, so that the individual binary elements 5 (see FIG. 4) represent two different binary values (e.g. “0” and “1”). These two types of binary elements can be realized, by way of example, by applying either one single droplet (e.g. representing the binary value “0”) or more than one droplets (e.g. representing the binary value “1”) as for example three droplets in FIG. 4 at the location of the respective matrix element. In another embodiment, the distinction between the two binary elements may be achieved by the diameter of the applied droplet.

Alternatively, the distinction between the two binary elements may be achieved by applying two types of dots, particularly ink dots, having different transparency to light. For example, for a binary value “0” a single droplet of ink is printed onto the lens molding surface, while for a binary value “1” a series of droplets, such as for example eight droplets, are printed onto the lens molding surface at the same position thereby superposing one another. As a result, the single droplet representing the binary value “0” may have a height of about 4 μm while the multiple droplets representing the binary value “1” may have an exemplary height of about 12 μm. The diameters of the single and multiple droplets in this embodiment are about the same and may be in the range of about 50 μm to about 120 μm, this being understood to particularly include and disclose the values of the boundaries. It goes without saying that the single droplet representing the binary value “0” has a greater transparency to light than has the droplet formed by the multiple droplets representing the binary value “1”, which consequently appears distinctly darker.

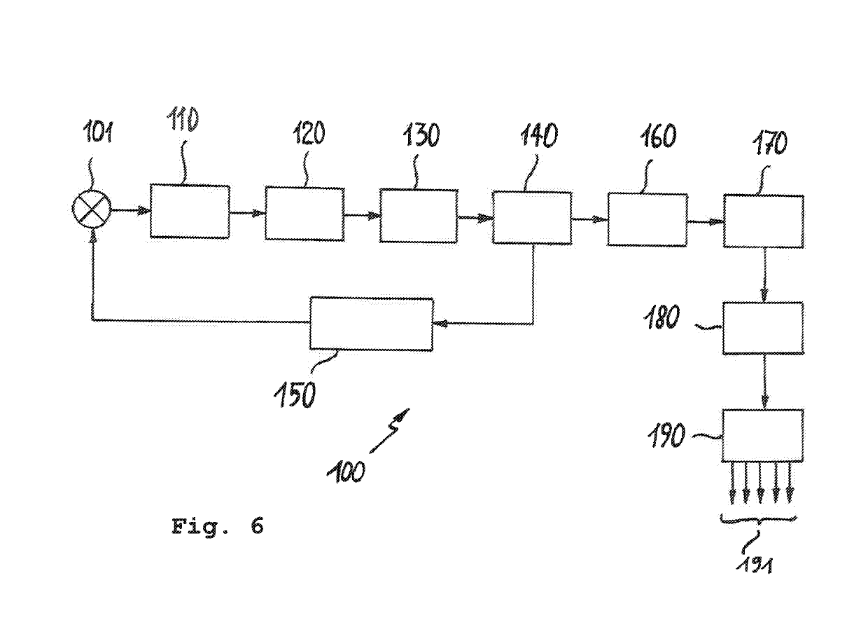

In FIG. 6 some stations of an embodiment of a production line 100 for toric contact lenses such as contact lenses, and in particular soft contact lenses, are shown. It is to be noted, that only stations are represented which are necessary for understanding the method according to the invention are shown in FIG. 6. At a starting point 101, typically a plurality of clean molds is starting their travel through the individual stations of the production line 100. Each mold comprises a male mold half and a female mold half having specifically shaped molding surfaces to manufacture a contact lens having specific lens parameters. Before the molds reach a dosing station 120, the molds are transported to an encoding station 110. In the encoding station 110, the lens identification code in the form of an one-dimensional dot pattern as described above is applied onto the molding surface of at least one of the male and female mold halves of each mold in a peripheral zone of the molding surface surrounding an optical zone of the respective molding surface.

The one-dimensional dot pattern is applied to a molding surface of the male or female mold half, so that during subsequent manufacture of the contact lens from the lens forming material the one-dimensional dot pattern is transferred from the molding surface of the male or female mold half to the rear surface or the front surface of the contact lens respectively. In particular, the one-dimensional dot pattern is applied to the peripheral zone of the molding surface of the female mold half prior to introducing the lens forming material into the female mold half. The one-dimensional dot pattern may be applied to the peripheral zone of the molding surface of the male or female mold half by applying a dot pattern corresponding to the one-dimensional dot pattern to the molding surface of the male or female mold half and temporarily fixating the applied dot pattern to the peripheral zone of the molding surface of the mold or of the male or female mold half, and by transferring the temporarily fixated dot pattern from the peripheral zone of the molding surface of the mold or of the male mold half to the peripheral zone of the contact lens during manufacture of the lens from the lens forming material.

For example, an ink dot pattern or wax dot pattern corresponding to the respective one-dimensional dot pattern is printed onto the molding surface in the peripheral zone of the respective female mold half with the aid of a commercially available Microdrop Dispenser Head®. For example, a commercially available UV-hardenable ink suitable for contact lenses can be used for that purpose. Alternatively, wax or wax mixture such as paraffin may be applied onto the molding surface for forming a one-dimensional wax dot pattern. Particularly, wax or wax mixture has a melting point high enough to be fixed on the molding surface but still may be eliminated by warm water washing of the molds in a mold cleaning station 150.

Alternatively to a valve jet printer, any other commercially available printing head may be used for applying the dot pattern.

In case ink dots are applied to the molding surface, the so applied ink dot pattern may then be partially hardened by exposure to UV-radiation (not shown) so as to fix the ink dot pattern on the surface of the peripheral zone of the female mold, as this is conventional in the art.

After the ink dot pattern or wax dot pattern (corresponding to the one-dimensional dot pattern) has been applied and fixed to each female mold half in the peripheral zone thereof, the molds are transported to the dosing station 120 in which a predetermined amount of a lens forming material is introduced into the female mold half. The molds are then closed by placing the respective male mold halves onto the respective female mold halves, and the closed molds are transported to a polymerization station 130. In the polymerization station 130, the lens forming material is polymerized and/or cross-linked to form the contact lens.

Polymerization and/or cross-linking can be achieved, for example, by exposure of the lens forming material to UV-radiation, as this is well-known in the art. During the polymerization/cross-linking of the lens forming material, the respective ink dot pattern or wax dot pattern is transferred from the peripheral surface of the respective female mold half to the peripheral zone of the respective contact lens, for example the ink dot pattern or wax dot pattern is embedded in the polymerized/cross-linked lens forming material.

The molds are then opened and the contact lenses each comprising its ink dot pattern or wax dot pattern in the peripheral zone thereof are removed from their respective molds in a contact lens demolding station 140 and are subsequently transferred to a lens washing station and lens inspection station 160.

When a wax dot pattern is applied to the molding surface and transferred to the toric contact lens, the wax generally will be removed in the lens washing station and leaving recesses in the peripheral zone 7 of the contact lens 1 corresponding to the desired one-dimensional dot pattern.

Of course, the respective contact lens may be subjected to various additional treatment steps after having been removed from their respective mold in the demolding station 140 to form the final contact lens, this is not explained herein in detail as such treatment steps are well-known in the art and depend on the respective lens forming material used. The empty molds are transported to a mold cleaning station 150 in which the molds are cleaned so that they can be re-used to form the next contact lens in the manner described above.

Turning back to FIG. 6, the contact lenses each comprising its lens identification code are transported to a lens inspection station 160, where each lens is inspected. And while in the lens inspection station 160, of course, the lens is also inspected for various defects, this is not described in detail here since this is conventional in the art. However, in addition thereto the lens identification code of each contact lens is read with a suitable device in the inspection station 160, for example with the aid of a CCD-camera. And although the system control of the production line 100 must at any time exactly know which contact lens is at which location in the production line in order to be able to fully control the production process, it can now be double-checked at the inspection station 160 by reading the lens identification code whether the contact lens that is supposed to be in the inspection station 160 actually is in the inspection station in any event the correct lens is then inserted into a contact lens package at the packaging station 170. In case the inspection station 160 is embodied so as to be able to measure the optical properties of the contact lens and since the lens identification code (via the number of the lens) also contains information on the optical properties of the contact lens, it is also possible to double-check whether the optical properties measured in the lens inspection station 160 correspond to the optical properties of the contact lens which are stored in the database for the contact lens having this lens number.

Once a contact lens has successfully passed the lens inspection station 160 it is transported to a package station 170 in which every single lens is transferred into a separate lens container which is typically filled with saline solution or any other suitable storage solution. The lens containers are then closed with a sealing foil, as this is conventional in the art, sterilized/autoclaved in a sterilization station 180 and are then forwarded to a storage station or area 190, from where they can be shipped in accordance with orders received; this being is indicated by the arrows 191 in FIG. 6.

The invention has been described with a reference to the particular embodiments shown in FIGS. 1 to 6. However, for the skilled person it is evident that many changes and modifications can be made without departing from the general concept underlying the invention. Therefore, the scope of protection is not intended to be limited to certain embodiments but rather is defined by the appended claims.

1. A toric contact lens (1) having a front surface and a rear surface, one of said front and rear surfaces including a toric optical zone, and a lens edge surrounding said contact lens (1), said contact lens (1) further having a ballast axis (3) and comprising at least one ballast mark (41, 42, 43) identifying the position of the ballast axis (3),
wherein each ballast mark (41, 42, 43) comprises a one-dimensional dot pattern (5), the one-dimensional dot pattern comprising a lens identification code and being arranged to extend radially towards the lens edge at an angular position relative to the position of the ballast axis (3), the angular position of the one-dimensional dot pattern (5) identifying the position of the ballast axis (3).

2. The contact lens (1) according to claim 1, wherein the one-dimensional dot pattern (5) represents a binary code including the lens identification code.

3. The contact lens (1) according to claim 1, wherein each of the front and rear surfaces comprise a central optical zone (6) which is surrounded by a peripheral zone (7), and wherein the one-dimensional dot pattern (5) is arranged in the peripheral zone (7) of the contact lens (1).

4. The contact lens (1) according to claim 2, wherein each of the front and rear surfaces comprise a central optical zone (6) which is surrounded by a peripheral zone (7), and wherein the one-dimensional dot pattern (5) is arranged in the peripheral zone (7) of the contact lens (1).

5. The contact lens (1) according to claim 1, wherein the at least one ballast mark (41, 42, 43) is arranged on the front surface of the contact lens (1).

6. The contact lens (1) according to claim 3, wherein the at least one ballast mark (41, 42, 43) is arranged on the front surface of the contact lens (1).

7. The contact lens (1) according to claim 1, wherein the contact lens includes two ballast marks (41, 42), the two ballast marks (41, 42) being symmetrically arranged at angular positions relative to the ballast axis (3).

8. The contact lens (1) according to claim 3, wherein the contact lens includes two ballast marks (41, 42), the two ballast marks (41, 42) being symmetrically arranged at angular positions relative to the ballast axis (3).

9. The contact lens (1) according to claim 4, wherein the contact lens includes two ballast marks (41, 42), the two ballast marks (41, 42) being symmetrically arranged at angular positions relative to the ballast axis (3).

10. The contact lens (1) according to claim 7, wherein the two ballast marks (41, 42) are arranged on an axis running perpendicular to the ballast axis (3) through a center of the contact lens, and wherein the two ballast marks (41, 42) are arranged at diametrical opposite locations on the peripheral portion (7) of the contact lens (1).

11. The contact lens (1) according to claim 8, wherein the two ballast marks (41, 42) are arranged on an axis running perpendicular to the ballast axis (3) through a center of the contact lens, and wherein the two ballast marks (41, 42) are arranged at diametrical opposite locations on the peripheral portion (7) of the contact lens (1).

12. The contact lens (1) according to claim 1, wherein the contact lens (1) includes a vertical ballast mark (43), which is arranged to coincide with the ballast axis (3).

13. The contact lens (1) according to claim 12, wherein the contact lens includes a single ballast mark (43) only which is arranged to coincide with the ballast axis (3).

14. A method of manufacturing of toric contact lenses (1), the method comprising the steps of:
providing a mold for the manufacture of toric contact lenses (1) having a ballast axis (3) and a lens edge surrounding said contact lens (1),
introducing a lens forming material into the mold,
transporting the mold through a plurality of manufacturing stations sequentially arranged along the production line to manufacture said contact lenses from the lens forming material, and
applying at least one ballast mark (4) to each of said toric contact lenses (1),
wherein the step of applying at least one ballast mark (4) to each of said contact lens (1) comprises applying at least one ballast mark (4) comprising a one-dimensional dot pattern (5) including a lens identification code at an angular position relative to the ballast axis in a manner such that the at least one ballast mark extends radially towards the lens edge of the respective contact lens (1), the angular position of the one-dimensional dot pattern (5) being arranged to identify the position of the ballast axis (3).

15. The method according to claim 14, wherein the one-dimensional dot pattern (5) represents a binary code including the lens identification code.

16. The method according to claim 14, wherein the step of applying the one-dimensional dot pattern (5) to each of said toric contact lens (1) comprises
applying the one-dimensional dot pattern to a peripheral zone of a molding surface, of the respective mold, and
transferring the one-dimensional dot pattern from the peripheral zone of the respective molding surface of the mold to the peripheral zone of the respective contact lens (1).

17. The method according to claim 15, wherein the step of applying the one-dimensional dot pattern (5) to each of said toric contact lens (1) comprises
applying the one-dimensional dot pattern to a peripheral zone of a molding surface, of the respective mold, and
transferring the one-dimensional dot pattern from the peripheral zone of the respective molding surface of the mold to the peripheral zone of the respective contact lens (1).

18. The method according to claim 16, wherein the one-dimensional dot pattern is applied to the molding surface of the mold using an ink-jet printer.

19. The method according to claim 17, wherein the one-dimensional dot pattern is applied to the molding surface of the mold using an ink-jet printer.

20. The method according to claim 16, wherein the one-dimensional dot pattern is applied to the molding surface of the mold using a valve jet printer.
